(19) United States
(12) Patent Application Publication
(10) Pub. No.: US 2008/0074809 A1
(43) Pub. Date: Mar. 27, 2008

(54) Current meter

(76) Inventor: Farhad Aframian, Charlotte, NC (US)

Correspondence Address: Farhad Aframian, 5850 Serrania Ave, Woodland Hills, CA, 91367, US

(21) Appl. No.: 11/528,842

(22) Filed: Sep. 27, 2006

(51) Int. Cl. H02H 7/00

(52) U.S. Cl. 361/1; 503/200

(57) ABSTRACT

A power level meter and method for an AC electrical appliance that can be implemented in the plug of the appliance, monitoring power in response load on the appliance and/or implemented as a module into which an existing appliance is inserted, thereby providing a retrofit solution for appliance AC current monitoring. By using thermo chromic ink and a heat generating resistor, the meter will display different colors on its face to illustrate electrical current flow or demand.

### CROSS-REFERENCE TO RELATED APPLICATION

### STATEMENT REGARDING FEDERALLY SPONSORED RESEARCH OR DEVELOPMENT

Not applicable

### REFERENCE TO SEQUENCE LISTING

Not applicable

### FIELD OF THE INVENTION

This invention relates to a current meter for residential or commercial use to easily and quickly check and monitor the amount of AC current through a wall outlet.

### BACKGROUND OF THE INVENTION

In many applications; it is desirable to monitor electrical current. For example, in an electric blanket, it is desirable to have multiple levels of heating in order to adjust for the external air temperature and user preference. These adjustments can demand more current. In a light, a low lighting level might be desirable to save energy or to set a mood while higher levels would be preferable for reading. For a fan, different fan speeds might be desirable depending upon room size and room temperature. Any such appliances or situations may vary the current draw and require monitoring.

For a variety of reasons, electronic components have only a finite useful life. At a certain point, these electronic components begin to function intermittently or function poorly or stop functioning altogether. One of the difficulties that arises when an electronic component begins to fail, or completely fails, is the current it may be pulling prior to or during failure. The current invention allows the monitoring of current being pulled of any household electrical appliance.

Another and more common problem of overloading household current is the attachment of too many fixtures through one wall outlet. The current device can be place between the wall outlet and any number of electrical appliances, extension cords, multi-plug adapter to safely and accurately monitor the amount of household current flowing to the appliance.

The invention clearly defines as an AC Current meter that can plug it in to a wall socket and then plug the load or appliance in to it and this device will show the amount of the AC current flowing to the appliance. The size of this device is 3.5″ long and 1.5″ diameter the material is rubber or hard plastic. This device looks like a plug on one side and socket from the other side.

There are three prongs on one side and two of them go to the other side with nothing in between. The 3rd prong has a very low resistor in the series. When the current flows through this resistor some heat generates. All three prongs are covered with rubber and on the surface of this device is a strip filled with THERMO CHROMIC ink that changes the color when the temperature changes.

Different levels of current control may often be obtained by modifying the appliances. Many of these alternatives involve a more complicated switch, additional wiring, and/or modifications to the appliance.

U.S. Pat. No. 3,979,601 to Franklin discloses a combination dimmer and timer switch mechanism which connects to the AC line and which implements appliance dimming in accordance with a predetermined timing sequence. A phase-controlled thyrister is used to regulate the appliance power. This system is fundamentally designed to be an open loop system without requiring user feedback for control and utilizes a complicated mechanical switch nor does it monitor flow.

U.S. Pat. No. 4,276,486 to Ahuja et al. discloses a two terminal power controller whereby momentary interruptions of the AC supply are used to signal building lights to change state (if on, to turn off, if off, to turn on). The intent is to allow both a distributed control where each light may be individually turned on, or a global control where all lights may be turned on or off.

U.S. Pat. No. 4,504,778 to Evans discloses a self-powered electronic control system wherein the control circuitry is powered directly off the AC line and wherein momentary power loss events are sensed and are used as inputs to the control scheme. In this system, the voltage drop across the switching device is used to provide power to the control circuitry. This is known as parasitic power. There are problems with using parasitic power. One problem is that the switching device can never be put into a fully on condition but must remain off for a portion of each half cycle so as to supply power to the control circuitry. This can result in undesirable electrical noise imposed upon the AC power line because of the required phase delay. A second disadvantage with parasitically powered devices is that because the entire control circuit is attached in electrical series with the load, a relatively complicated control circuit is required to distinguish between the positive half cycle and the negative half cycle of the AC power as applied to the load. A parasitically powered controller that is series connected with the load cannot distinguish between a switch at the load and a switch at the source. This limits the ability to implement multiple control schemes. Another problem with parasitic power is that the load must be substantially resistive. This is because the control scheme relies upon the voltage and current waveforms being in-phase in order to sense switch closures. A parasitically powered device can only control a thyristor by firing quadrants I and IV. Finally, because the parasitically powered device derives its own power by being electrically in series with the load, it must power the load in order to power itself. This means that when the load is turned off, as through an open switch, power is removed from the controller. Also, this means that the load must have some specific minimum value or else the controller would not receive enough power to operate.

U.S. Pat. No. 4,534,957 to Hollaway discloses a remotely controlled light flasher for an outside building light. This invention describes a control circuit for turning on and off the power to an electrical load with a prescribed timing characteristic.

U.S. Pat. No. 4,695,739 to Pierce discloses a multifunction switch-controlled lamp circuit whereby the number of contact closures of a single pole, single throw switch that occur within a pre-specified time interval are counted and interpreted and then used to control power to a load. The control circuit is parasitically powered and has the problems associated with that design approach.

U.S. Pat. No. 5,030,890 to Johnson discloses a two terminal incandescent lamp controller that is connected in electrical series with a load and a remote switch and that is disposed in a package that is inserted in the base of an Edison style lamp socket. Contact closures at the remote switch are counted and power to a load is controlled at an electronic switching device in response thereto. This control scheme is half cycle parasitically powered and exhibits the problems associated with that design approach. The packaging can present a problem because a user must install the package into the lamp socket and must replace the package with each new bulb. Furthermore, having this package located under a bulb severely limits the ability of the thyristor to dissipate internally generated heat and limits the amperage of the lamp load that can be attached without monitoring current of voltage flow.

U.S. Pat. No. 5,844,759 to Hirsh et al. discloses an electrical shock protection device for appliances that may be built into the plug of an appliance cordset and that may communicate fault or other status information to a remote location over a two-wire power line.

The present invention is of a low cost electronic monitoring device that may be used to view power levels or flow to an electrical appliance without requiring a special socket, special switches, or modification to the appliance. The invention is powered from a parallel connection to the AC line (no parasitic powering) and is preferably mounted temporarily between the wall socket and any electrical appliance.

### SUMMARY OF THE INVENTION

The current invention is an AC current meter that can be plugged into a wall socket and then plug the load into the other side to show the amount of the AC current flowing to the load. The size of this device is 3.5″ long and 1.5″ diameter the material is rubber or hard plastic. The current device looks like a plug on one side and socket from the other side. There are three prongs on one side of the device. Two of the prongs pass directly through the device carrying the current directly to the load unencumbered. The 3rd prong has a very low “resistor” in series. When the current flows through this resistor some heat generates. The surface of this device is a strip filled with thermo chromic ink that changes the color when the temperature changes.

A power level meter for an AC electrical appliance that can be implemented at the plug of the appliance, monitoring power or load to avoid overloading the circuit. In addition, the independent monitoring of voltage current by use of thermo chromic ink, the user can quickly and easily view levels for safety and reliability of the appliance.

### BRIEF DESCRIPTION OF THE DRAWINGS

In order that the invention may be clearly understood and readily carried into effect, preferred embodiments of the invention will now be described, by way of example only, with reference to the accompanying drawings wherein:

### DESCRIPTION OF PREFERRED EMBODIMENT

While the fundamental novel features of the invention have been shown and described, it should be understood that various substitutions, modifications and variations may be made by those skilled in the art without departing from the spirit or scope of the invention. Accordingly, all such modifications or variations are included in the scope of the invention as defined by the following claims:

Having thus described the invention, what is desired to be secured by a patent is:

What is claimed is:

1. A monitoring apparatus for electrical appliances having a plug, a load, and requiring no more than two electrical current conductors connecting said plug to said load, said apparatus comprising: a resistor to heat thermo chromic ink that is located between the wall outlet and the load or appliance.

2. The meter apparatus of claim 1 wherein said meter is entirely disposed within the plug of the appliance cordset.

3. The control apparatus of claim 1 wherein said apparatus is entirely disposed within a plug-in module.

4. The control apparatus of claim 1 wherein said meter is filled with thermo chromic ink.

5. The control apparatus of claim 1 wherein said meter contains a heat transferring resistor in contact with the thermo chromic ink.
